(19) United States
(12) Patent Application Publication
(10) Pub. No.: US 2002/0139046 A1
(43) Pub. Date: Oct. 3, 2002

(54) Seed with a covering which contains a nitrogenous fertiliser

(76) Inventors: Heinrich Weber, Bad Sooden Allenford (DE); Karl Jungwirth, Waldkappel (DE); Ernst-Ludwig Hoerner, Eschwege (DE)

Correspondence Address: STRIKER, STRIKER & STENBY, 103 East Neck Road, Huntington, NY, 11743, US

(21) Appl. No.: 10/051,880

(22) Filed: Jan. 17, 2002

(30) Foreign Application Priority Data
Jan. 19, 2001 (DE) 101 02 555.6

(51) Int. Cl. A01C 1/06; A01C 21/00

(52) U.S. Cl. 47/57.6

(57) ABSTRACT

The invention relates to seed with a covering which contains a nitrogenous fertiliser. The nitrogenous fertiliser contains a fast-acting component, which is intended for the young development of the seed, and a slow-acting component, which is intended for the formation of a time-release of nitrogen. The weight ratio of the two components is chosen dependent upon the requirements of the respective seed.

The invention relates to seed with a covering which contains a nitrogenous fertiliser.

The most important nutrient for agricultural crops such as sugar beet, maize, rape, cereals and vegetables is supplied by the so-called nitrogenous fertilisers. It is generally understood that these include fertilising agents which contain nitrogen in a form which is readily soluble in water, fast-acting and therefore readily utilisable by plants for substance balance. This is the case for example for inorganic salts with ammonium- or nitrate components, but also for some organic compounds and here especially for urea which is likewise readily soluble in water. There are used predominantly so-called compound fertilisers with potassium and phosphorus (N—P—K), supplemented with trace elements.

In traditional agriculture, nitrogenous fertilisers are applied in recommended quantities of for example 100 to 120 kg N/ha, but also up to 250 kg N/ha in the case of poorly cared-for soils. For this purpose, in addition to natural fertilising agents such as liquid manure and stable manure, which are mineralised during the vegetation period by means of micro-organisms, various artificial fertilisers of the previously mentioned type are also suitable, which fertilising agents are available in the form of granulates or are dissolved in water and able to be sprayed and are generally applied on the fields over large surface areas like natural fertilising agents. This has the result that the largest part of the nitrogenous fertilisers does not reach the plant seeds and roots, in addition is easily washed away by rain and therefore is not available for the desired cycle. On the basis of experiments and estimates it can be assumed that up till now at most 60% of nitrogenous fertilisers of this type have actually been utilised, whilst the unused remainder reaches stretches of water and thereby leads to considerable environmental problems. These problems can in fact be slightly reduced by means of introducing the nitrogenous fertilisers directly next to or in the rows of seed, however measures of this type involve other disadvantages such as for example target—and metering accuracy.

Furthermore, it is already known (DE 21 35 410 A1) to provide seed, by means of pilling, granulating or incrustation, with a nutrient-containing covering which contains soluble alkali- and alkaline earth compounds. However, if such components are introduced into the covering in the required quantities, they entail the danger that they hinder the growth or even cause destruction of the seeds or plants. Potassium and other nutrients, particularly nitrogen salts, have namely the characteristic that, although indeed growth-promoting in traces, in larger quantities they have a germicidal effect. Therefore, if larger quantities of nutrients of this type which are present in the covering are released very quickly due to their high solubility, then his does not result in the desired fertilisation but rather in premature dying of the plants. It is thus not possible to introduce nutrients of this type into the coverings in the quantities which are sufficient for a vegetation period.

In addition, it is also already known (DE 21 35 410 A1) to enrich the coverings with chemical compounds in the form of crystallised phosphates (for example KMgPO₄) and their hydrates which are less readily soluble in water and serve the purpose of keeping low the water activity at the seeds, increasing their storage life and achieving a better metering of the nutrients which are supplied to the germinating plants. Coverings of this type could in principle be enriched also with nitrogen in the form of ionically constituted nitrogen salts, however these are in practice unsuitable as treatment means because of their water solubility which is 1000 ppm and more. In the required quantities they would rather negatively affect the germination, like the other inorganic salts, and at least cause germintion retardations, germination damage and leaf necroses.

The difficulties caused by inorganic salts could be avoided up to a certain level according to a further known proposal (US-PS 60 40 673) by the application of urea. The urea however is thereby supposed to serve only for activation and stimulation, being applied in aqueous solution despite its covalent bonds and with application quantities of at most 16.5 g of the solution corresponding to 2.2 g of pure nitrogen per kilogram of seed, which is still tolerable for the seedlings. Practical applications of urea in conjunction with seed coverings have however to date not become known.

Finally, organic nitrogen suppliers are known, which have no negative effects on the germination behaviour and which, because of the required decomposition time, release the nitrogen very slowly, i.e. are slow-acting. Horn meal could serve for example as organic nitrogen supplier, the nitrogen proportion of which is mineralised in the soil by micro-organisms. An application of materials of this type in seed coverings leads however to seed drilling problems in the case of pre-set calibration diameter limits because of the mostly only small nitrogen content (for example less than 13% by weight). A further problem would thereby result in that the initial effect of such a nitrogenous fertiliser would be very imperfect, i.e. a speedy start to growth, which is the basis for the further development of the plants, would be prevented. In addition, coverings with such large masses and layer thicknesses would be required that the gas and water exchange of the germinating seeds with the natural environment would be made difficult.

An unavoidable consequence of the numerous problems which occur in the use of seed coverings which contain nitrogenous fertilisers is the fact that the nitrogenous fertilisation has up till now been effected exclusively in a conventional manner and the disadvantages which arise thereby through over-fertilisation have been accepted.

An important object of this invention is, therefore, to provide a seed having a covering which contains a nitrogenous fertiliser in such a manner that the nitrogen can be metered at the seed in a targeted, selected manner.

A further object of this invention is to design the covering containing a nitrogenious fertiliser such that the nitrogen can be used and become effective substantially over the entire vegetation period.

Yet another object of this invention is a seed covering comprising nitrogen in such a manner that the nitrogen can only be washed away to a small extent by rainfall or the like.

These and other objects are solved in accordance with this invention by a seed with a covering which contains a nitrogenous fertiliser and being characterised in that the nitrogenous fertiliser contains a fast-acting component, which is intended for the young development of the seed, and a slow-acting component, which is intended for the formation of a time-release of nitrogen for the time after the young development, the weight ratio of the two components being chosen dependent upon the requirements of the seed.

The invention comprises substantially a splitting-up of the fertilising effects directly at the seed by means of a fast-acting and a slow-acting component, taking account of the requirements of the respective crop. It is understood thereby that within the scope of the present invention, a “fast”-actin component concerns for example a substance which is readily soluble in water and provides the nitrogen available therein to the germinating seed already during the early young development in the spring and in a quantity required for promoting germination, whilst the “slow”-acting component has in practice no influence on the young development, is only marginally washed away even during heavy rainfall and only effects the required fertilisation in later periods of time of the vegetation period, without thereby effecting damage to the seedling.

Notwithstanding the fact that nutrients which act fast and slowly in the sense of the present invention are already known per se, a particular advantage of the invention resides in the fact that, by means of the introduction of these nutrients into the seed covering, a concentration of both components of the nitrogenous fertiliser is achieved in the immediate vicinity of the seeds. On the one hand a considerable saving in fertilising agent is therefore possible in comparison with the conventional fertiliser consumption. On the other hand, negative physiological germination effects can be effectively avoided in the covering because of the exact dosability, particularly of the component which is readily soluble.

Further advantageous features of the invention appear in the sub-claims.

The invention is explained subsequently in greater detail with reference to a preferred embodiment, given by way of example.

The covering according to the invention contains two components of synthetic nitrogenous fertilisers. In order to achieve a desirable initial effect a first, fast-acting component is used, which for preference contains at least one compound which is readily soluble in water. The total quantity of this component in the covering, measured for example in grams of nitrogen per kilogram of seed, is measured such that the comparatively small nitrogen requirement in the early development phases of the seed is indeed certainly met, but germination damage nevertheless is definitely avoided. On the other hand, a second, slow-acting component, which preferably contains at least one compound which is not readily soluble in water, is added to the covering in such a quantity that it has a time-release effect in the latter, forms the main mass of the nitrogenous fertiliser and becomes effective during the part of the vegetation period which follows the young development. The weight ratio of the fast-acting component to the slow-acting component depends, for avoidance of germination damage, on the requirements of the respective crop, is preferably less than one and, depending upon the total N-quantity in the covering per kg of seed and upon the N-content of the fertilisers used, can be for example 1:2 to 1:28 and less in the case of sugar beet.

The fast-acting component comprises preferably an inorganic salt with ionic bonding, but can also however comprise an organic substance which is adequately soluble in water, such as for example urea with covalent bonds, even if on this occasion the solubility is not achieved by dissociation in the water.

On the other hand the slow-Acting component comprises preferably at least one organic substance which is only soluble in water with difficulty and has covalent bonds. For this purpose, such organic nitrogen compounds are possible in which the nitrogen is converted predominantly by means of microbial decomposition and via ammonium into nitrate compounds. There are thereby preferred such substances, the decomposition of which increases with the temperature, and thus is greater in warmer times of the year, corresponding to a greater requirement on the part of the plants, than in colder periods. Below approximately 6-10° C. on the other hand, practically no conversion by soil bacteria or the like should ensue in the case of these substances, in order that they are also suitable for the seed treatment of overwintering crops, such as for example rape and cereals. The advantage is thereby achieved that the release of the nutrients is only effected when the plants are ready to take up these nutrients under the natural conditions. It is obvious that there are compounds, such as for example urea, which partially act quickly via solubility and partially slowly via microbial decomposition.

In the case of organic nitrogen compounds the water solubility can be approximately controlledvia the C:N ratio in a molecule. Since, however, high nitrogen contents and overall low covering masses are desired for the seed treatment, the C:N ratio should not be greater than 10:1.

There are suitable as slow-acting nitrogenous fertilisers of the type described numerous cyclic compounds such as pyrroles, pyrilidines, pyridines etc., acyclic compounds such as amines, amides, amino acids etc. and also covalent nitrogen-phosphourus compounds, which are all practically insoluble in water and from which the nitrogen is only released, for example by specific micro-organisms, when their optimal living conditions (for example higher soil temperature and moisture) are also achieved naturally for the seeds to be germinated or the plants, For the release of the nitrogen, particularly structure elements are thereby advantageous in which at least one nitrogen atom adjoins a functional group such as for example the CO-carbonyl group. Particularly preferred here are urea and its condensation products with carboxylic acids or aldehydes such as for example with formaldehyde, crotonic aldehyde or isobutyr-aldehyde. These materials particularly fulfil the mentioned criteria.

One embodiment of the invention contains a urea mixture with urea (solubility 1200 g/l water at 20 (C, C:N=1: 2 with 48% nitrogen content) as fast-acting component and with isobutylidenediurea (solubility (2 g/l water at 20 (C, C:N=3:1 with 28% nitrogen content) as slow-acting component.

The production of the covering made of such a mixture begins with its milling to a particle size which is smaller than 0.3 mm, in order to make possible accurate dosing. A few grams up to kilograms of nitrogen per kilogram of seed are used depending upon the size of the seed and the quantities of seed per hectare, an accuracy of (15% by weight of nitrogen relative to the desired value being observed in the case of the individual seed particle. These quality requirements are fulfilled for example with rotor/stator apparatus, as are generally known for the production of pillings and incrustations.

Advantages of such a type of production of the covering according to the invention lie in a speedy and uniform growth of the young development up to harvesting because of the fast action of the urea and a subsequent uniform row formation because of the slow action of the isobutylidenediurea, particularly also in the case of crops such as for example sugar beet and maize with large row spacings (for example 40-60 cm) and large seed spacings within each row (for example 18 cm) In addition, it is particularly advantageous, at the first occurrence of pests or weeds in early portions of a growing period (for example May onwards), that the roots of the plants are already so stable and capable of resistance because of the rapid growth, that pest attacks and production of weeds are less critical than when using known fertilising methods. Since, in addition, the flow of water is directed towards the seed and after germination to the roots, the danger of washing away of the nitrate is reduced to a minimum.

Furthermore, it is clear that the nitrogenous fertiliser can be combined with a phosphorus/potassium treatment, in which for example phosphates which are not readily soluble in water are added to the described covering (DE 21 35 410 A1). Via a suitable mixture ratio of these compounds with the two nitrogen variants, urea and isobutylidenediurea, an NPK ratio of 1:1:1 can be obtained corresponding to the normal recommendations. In addition, chelatised trace elements can be added in a known manner to the covering.

### EXAMPLE 1

Experiments on fields were carried out with sugar beet seed which was covered with nutrients. A fertiliser mixture was used as nitrogen supplier which for 100 g contains in total 32 g of nitrogen, of which 28 g is allotted to the isobutylidenediurea source and 4 g to the urea source. The sugar beet were then pilled with the mixture in the known manner in a rotor/stator granulating apparatus and, for this purpose, brought to the prescribed calibre of 3.5-4.75 mm with a composition made of the normal shell mass components and binding agents, the prescribed insecticide and fungicide quantifies being additionally incrusted on the covering.

The following variants were then tested on the field with normal operational fertilising in practical conditions:

variant a.: 100 g of the mixture 32 g N/E,

variant b.: 200 g of the mixture 64 g N/E and

variant c.: 300 g of the mixture=96 g N/E,

1 E=100,000 pills being an adequate quantity of pills for approximately 1 ha beet area.

10 or 11.5 weeks after the sowing, the following beet weights were obtained:

| Evaluation in weeks | Field 1 after | Field 2 after |
|---|---|---|
| after sowing | 10 weeks | 11.5 weeks |
| Control without N | 100 | 100 |
| a. 32 g N/E | 109 | 98 |
| b. 64 g N/E | 120 | 111 |
| c. 96 g N/E | 133 | 115 |

The control quantity without N which is normalised respectively to the value 100 thereby means that here seed with a nitrogenous fertiliser-free covering was observed in one field portion which was provided with the nitrogenous basal fertiliser (on average approximately 120 kg N/ha), to which the farmer is accustomed and possibly is recommended by agricultural authorities. On the other hand, the values of 32 g N/B, 64 g N/E and 96 g N/E mean that here, on field portions with the same nitrogenous basal fertiliser, seed with coverings was raised, which was provided with a covering containing the nitrogenous fertiliser according to the invention, said covering containing 32 g, 64 g or 96 g of the described urea/isobutylidenediurea mixture on 100,000 pills.

The above Table shows that the beet weight in both fields, starting from the normalised initial value 100, increases significantly with the added quantity of nitrogenous fertiliser in the covering.

An examination of the variant c, on four different fields led in addition to the following average beet weights, averaged over 200 beet respectively, in g per beet:

| Evaluation | Field 1 | Field 2 | Field 3 | Field 4 |
|---|---|---|---|---|
| in weeks | after | after | after | after |
| after sowing | 9 weeks | 10 weeks | 11.5 weeks | 14.4 weeks |
| Control with- | 106 | 114 | 131 | 206 |
| out nitrogen | | | | |
| c. 96 N/E | 102 | 152 | 151 | 248 |

The above Table makes it clear that the beet weight which is achieved after 9 weeks, starting from initial values which are approximately equal, in the case of conventional fertilising and fertilising according to the invention increases substantially more steeply in the case of sugar beet which have the covering provided according to the invention than in the case of normal fertilising (after 14.5 weeks 248 g instead of 206 g).

### EXAMPLE 2

Once again experiments on fields were carried out with sugar beet seed which was provided with a covering, up to the limit which has been possible to date with said seed in the case of sugar beet, on the basis of the prescribed calibre of 3.5 mm to 4.75 mm. The seed covering per E comprised exclusively a fertiliser mixture which contained, per 100 g of fertiliser, 28 g of nitrogen from isobutylidenediurea and 1 g of nitrogen from urea. In contrast to Example 1, a nitrogen quantity of 710.5 g N/E was used.

The following harvest results were obtained from two fields with normal operational fertilising in practical conditions in the middle of October:

| | | |
|---|---|---|
| Yields in | Field 1 | Field 2 |

| decitonnes | absolute | relative | absolute | relative |
|---|---|---|---|---|
| Control seed | 650 dt/ha | 100 | 540 dt/ha | 100 |
| without N | | | | |
| Seed with | 682 dt/ha | 105 | 594 dt/ha | 110 |
| 710.5 g N/E | | | | |

The analytically determined nitrogen content of the soil, which was mineralisable and available for the plants, was during sowing 215 kg N/ha in field 1 and 126 kg N/ha in field 2. Although field 1 was thus very well provided with nitrogen and a high yield was achieved, the fertiliser of 710.5 g N/E which was contained in the seed covering effected an additional yield increase of approximately 5%. On field 2 with the lower yield, an additional yield increase of approximately 10% was in fact achieved.

In addition, it was shown that the variation coefficient as the measure for the dispersion of the beet weights in the case of the control variant is significantly greater than in the case of the fertiliser variant. With the fertiliser variant, a more uniform growth can accordingly be achieved.

The invention can also be applied to other crops such as for example rape, cereals, maize and vegetables, which in comparison with sugar beet possibly make necessary different quantities of nitrogenous fertiliser in the covering in order to achieve the desired initial or long-term effects. It is obvious that the values which are given for sugar beet are examples only, which can be chosen differently according respectively to solubility and decomposition speed of the components involved. Naturally it is also possible to use the seed according to the invention without the nitrogenous basal fertiliser described by means of the example, by introducing additionally into the covering an equivalent of nitrogen which corresponds to said fertiliser, In this manner, at least those considerable quantities of artificial fertliser, which up till now have reached the ground water unused, can be greatly reduced. This is substantiated subsequently in Example 3.

### EXAMPLE 3

Winter rape was pilled with the fertiliser mixture which, as in Example 1, contained 28 g of nitrogen from isobutylidenediurea and 4 g of nitrogen from urea per 100 g of fertiliser. The quantity of nitrogen which was applied by the seed covering was approximately 2 kg N/ha. The rape fertiliser pills, which were additionally treated with the prescribed fungicide and insecticide quantities, and a control seed, which had no fertiliser covering, were sown on a field in August in practical conditions. Three long plots I, II and III which were situated adjacent to each other were laid out. In February of the following year, the normal operational supplementary fertilising was spread by the farmer and in fact in a quantity of 45 kg N/ha in plot I and of 90 kg N/ba in plots II and III. With almost the same level of plants on all three plots there was produced after threshing at the end of the following July the following result:

| Seed | Plot I | Plot II | Plot III |
|---|---|---|---|
| with kg N/ha | 2 kg | 2 kg | without |
| from seed | | | |
| Supplementary | 45 kg | 90 kg | 90 kg |
| fertilising with kg | | | |
| N/ha over a large | | | |
| area | | | |
| Yield of rape in dt | 35.5 | 37.3 | 34.8 |
| pro ha (absolute) | | | |
| Yield of rape per | 102 | 107 | 100 |
| ha (relative) | | | |

The experiment shows that considerable quantities of nitrogenous fertiliser can be saved by the farmer with a nitrogen-containing seed covering with an almost identical yield of 35.5 decitonnes relative to 34.8 decitonnes in plots I and III. The saving in the Example was 43 kg N/ha or approximately 48%. In addition, the results from plots I and III show that 90 kg N/ha, which corresponds to 333 kg of a commercially available 27% N-fertiliser such as lime ammonium nitrate, with seed without nitrogenous covering (plot III), produce the same yields as a nitrogenous covering of in total 2 kg N/ha and a supplementary fertilising of only 45 kg N/ha, which corresponds approximately to 166 kg of lime ammonium nitrate per ha (plot I), so that 2 kg N/ha in the covering are equivalent to a surface dressing of 45 kg N/ha.

Furthermore, it can be established that in the case of rape as overwintering crop type, the quantity of nitrogenous fertiliser of approximately 2 kg, which is introduced with the covering, remains effective over the entire vegetation time of 11 months, which confirms the long-term effect indicated above. Finally, there arises from the results in plots II and III that, with the same supplementary fertilising, the additional application of the nitrogenous fertiliser covering produces a yield increase which here is approximately 7%.

The invention is not restricted to the described embodiments, which can be modified in a multiplicity of ways. In particular, the invention is not restricted to the application of exclusively organic compounds, but can also be realised with corresponding inorganic compounds, for example if, in case of the required nitrogen quantities in the covering, no damaging impairment of the gas exchange and of the water delivery occur, and no negative physiological germination effects are to be feared due to nitrogen quantities which are too great or are dissolved too quickly. In addition, care should be taken that the sizes (diameters) of the coverings are subject to certain limitations, if the sowing machines, which are normally used for seed of this type, should continue to be able to be used. Finally, it goes without saying that the various features of the invention can also be applied in combinations other than those descried and illustrated.

It will be understood that each of the elements described above, or two or more together, may also find a useful application ill other types of seeds differing from the types described below.

While the invention has been illustrated and described as embodied in a seed with a covering containing a nitrogenous fertiliser, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. Seed with a covering comprising a nitrogenous fertiliser, wherein said nitrogenous fertiliser contains a fast-acting component, which is intended for the young development of the seed, and a slow-acting component, which is intended for the formation of a time-release of nitrogen for the time after the young development, the weight ratio of the two components being chosen dependent upon the requirements of the seed.

2. Seed according to claim 1, wherein said weight ratio of the fast-acting component to the slow-acting component is less than one.

3. Seed according to claim 2, wherein said weight ratio of the fast-acting component to the slow-acting component in the case of sugar beet is less than approximately 1:2.

4. Seed according to claim 1 or 2, wherein said fast-acting component contains at least one compound which is readily soluble in water.

5. Seed according to claim 1 or 2, wherein said slow-acting component contains at least one component which is not readily soluble in water and becomes effective predominantly or exclusively by means of bacterial decomposition.

6. Seed according to claim 1, wherein said nitrogenous fertiliser contains an organic compound with a structural element in which at least one nitrogen atom adjoins a functional group.

7. Seed according to claim 6, wherein said nitrogenous fertiliser contains urea and its condensation products with aldehydes.

8. Seed according to claim 7, wherein said nitrogenous fertiliser contains a mixture of urea and isobntylidenediurea.

9. Seed according to claim 1, wherein nutrient salts in the form of alkali/alkali earth salts are mixed with the nitrogenous fertiliser.

10. Seed according to claim 9, wherein said salts comprise phosphates.

11. Seed according to one of the claims 1, 6, 7, 8, 9 and 10 and being provided in pilled, granulated or incrusted form.
